(19) United States
(12) Patent Application Publication
(10) Pub. No.: US 2023/0376817 A1
(43) Pub. Date: Nov. 23, 2023

(54) Systems and Methods for Deterministic Photonic Quantum Computing in a Synthetic Time Dimension

(71) Applicant: The Board of Trustees of the Leland Stanford Junior University, Stanford, CA (US)

(72) Inventors: Ben Bartlett, Stanford, CA (US); Avik Dutt, Stanford, CA (US); Shanhui Fan, Stanford, CA (US)

(73) Assignee: The Board of Trustees of the Leland Stanford Junior University, Stanford, CA (US)

(21) Appl. No.: 18/247,959

(22) PCT Filed: Oct. 4, 2021
(86) PCT No.: PCT/US21/71712

§ 371 Date: Apr. 5, 2023

Related U.S. Application Data
(60) Provisional application No. 63/087,661, filed on Oct. 5, 2020.

(51) Int. Cl. G06N 10/40

(52) U.S. Cl. CPC G06N 10/40

(57) ABSTRACT

Many embodiments describe a scalable scheme for performing quantum computation in a synthetic time dimension which uses a single coherently controlled atom. Quantum operations applied to the atomic qubit can be teleported onto the photonic qubits via projective measurement, and arbitrary quantum circuits can be compiled into a sequence of these teleported gates. The synthetic time dimension can negate the need for many identical quantum emitters to be integrated into a photonic circuit, and the single atom may provide effective all-to-all connectivity between photonic qubits.

### CROSS-REFERENCE TO RELATED APPLICATIONS

The current application claims the benefit of and priority to U.S. Provisional Patent Application No. 63/087,661 entitled “Deterministic Photonic Quantum Computation in a Synthetic Time Dimension” filed Oct. 5, 2020. The disclosure of U.S. Provisional Patent Application No. 63/087,661 is hereby incorporated by reference in its entirety for all purposes.

### GOVERNMENT SPONSORED RESEARCH

This invention was made with Government support under contract FA9550-17-1-0002 awarded by the Air Force Office of Scientific Research and under contract N00014-17-1-3030 awarded by the Department of Defense. The Government has certain rights in the invention.

### FIELD OF THE INVENTION

The present invention generally relates to systems and methods for deterministic photonic quantum computing; and more particularly to deterministic photonic quantum computing in a synthetic time dimension.

### BACKGROUND OF THE INVENTION

Classical computers switch transistors either on or off to symbolize data as ones and zeroes. In contrast, quantum computers use quantum bits, or qubits. A qubit is the basic unit of quantum information. A qubit can be the quantum version of the classical binary bit physically realized with a two-state device. A qubit can be in a state of superposition where they simultaneously act as both 1 and 0.

Photonics can offer many advantages for quantum information processing: optical qubits have long coherence times, are maintainable at room temperature, and are optimal for quantum communication. Weakly coupled to their environment, photons do not suffer the decoherence issues of matter-based systems, and thus may not require operation at millikelvin temperatures or in high vacuum. A main difficulty faced by quantum computing (QC) architectures may be scalability, but this is especially true for photonic systems. Since optical qubits need to propagate, processing is better to be done mid-flight by passing the photons through sequential optical components. Since photonic quantum gates are physical objects (as opposed to, e.g. sequential laser pulses for atomic qubits), complex quantum circuits can be prohibitively large to implement. Moreover, the non-interacting nature of photons can make implementing two-photon gates required for universal computation a significant challenge.

### BRIEF SUMMARY OF THE INVENTION

Systems and methods for deterministic photonic quantum computating in synthetic dimensions are described. Many embodiments provide deterministic photonic quantum computation in a synthetic time dimension. Many embodiments use a single quantum emitter to implement a large number of distinct quantum gate operations, which can improve the scalability of scattering-based photonic quantum computation. Some embodiments provide a single atom embedded in a cavity as an element to induce photon-photon interaction. Certain embodiments provide different configurations to induce photon-photon interaction. Examples of different configurations include (but are not limited to): a quantum emitter directly embedded in the waveguide. Several embodiments use a single controllable atomic qubit and a fiber ring which can store many counter-propagating photonic qubits. Given a fixed number of qubits, the physical size can be independent of the depth of the circuit to be implemented. In several embodiments, quantum operations applied to the atomic qubit can be teleported onto the photonic qubits via projective measurement. In some embodiments, arbitrary quantum circuits can be compiled into a sequence of teleported gates. A number of embodiments provide that synthetic time dimensions can negate the need for many identical quantum emitters to be integrated into a photonic circuit. In certain embodiments, the single atom can provide effective all-to-all connectivity between photonic qubits. Many embodiments provide a fully deterministic photonic quantum computation. Deterministic photonic quantum computation in accordance with several embodiments does not require single-photon detectors. Some embodiments provide that an error rate per gate is of order 10⁻⁴.

In several embodiments, the deterministic photonic quantum computer can include at least one optical storage ring including (but not limited to) a fiber ring. Photonic qubits circulating in fiber rings may not be directly controllable. Some embodiments provide that the deterministic photonic quantum computers can include at least one optical switch in fiber rings. In some embodiments, photon sources including (but not limited to) a single photon source or a laser, can generate photon pulses. Qubits can be encoded as trains of single photon pulses counter-propagating through an optical storage ring. In some embodiments, the at least one fiber ring can be coupled to a cavity. The cavity can have a single atom. In a number of embodiments, a single atomic qubit in a cavity can be coherently controlled by a laser. In several embodiments, optical switches can selectively direct photons through a scattering unit to interact with a single atom in a cavity. Photons can interact with a single atom and return to fiber rings. In a number of embodiments, the atomic state can be measured and operations can be teleported onto photons. Several embodiments provide that control of a single atom can be sufficient to control all photonic qubits.

Many embodiments provide that the deterministic photonic quantum computers can be implemented in a fiber optic system and/or in an integrated on-chip platform. Quantum computers have applications ranging from logistics, optimization, to drug designs. Fault-tolerant quantum computers may be applied in quantum simulation including (but not limited to) quantum simulation of biological structures and/or pharmaceutical development, and in quantum machine learning.

One embodiment of the inventions includes a photonic quantum computer comprising:
at least one photon source, wherein the photon source generates at least one single photon pulse, wherein at least one photonic qubit is encoded in the at least one single photon pulse;
at least one optical storage ring, wherein the at least one single photon pulse propagates the optical storage ring;
at least one optical switch, wherein the at least one switch is part of the optical storage ring;
at least one cavity comprising a single atom source and at least one laser, wherein the single atom source comprises an atomic qubit;
at least one beamsplitter;
at least one phase shifter; and
at least one mirror.
   The at least one optical switch directs the at least one single photon pulse from the at least one optical storage ring through the at least one beamsplitter and the at least one phase shifter into the at least one mirror. The directed at least one single photon pulse scatters with the single atom source and returns to the at least one optical storage ring. The atomic qubit is projectively measured and teleported to the at least one photonic qubit.

In an additional embodiment, the at least one photon source is either a single photon source or a laser.

In another embodiment, the at least one optical storage ring is an optical fiber ring.

In a further embodiment, the single atom source is selected from the group consisting of: a single atom, a single quantum emitter, and a single quantum dot.

In another further embodiment, the single atom has a transition near 1550 nm.

In a further yet embodiment, the single atom is selected from the group consisting of: strontium, rubidium, caesium.

In a still further embodiment, the single atom source has a ∧-shaped three-level structure.

In a yet additional embodiment, the at least one mirror is a waveguide.

In a further still embodiment again, the at least one waveguide is coupled with the at least one cavity.

In another further still embodiment, the at least one beamsplitter is a static 50:50 beamsplitter.

In yet another embodiment, the at least one phase shifter is a π/4 phase shifter.

In a further embodiment again, the at least one laser coherently controls the single atom source.

In another embodiment again, the photon source generates two single photon pulses, and a first of the two single photon pulses propagates the optical storage ring in a clockwise direction and a second of the two single photon pulses propagates the optical storage ring in a counter clockwise direction.

In a further additional embodiment, the photonic quantum computer is deterministic.

In another additional embodiment, the photonic quantum computer uses a synthetic time dimension.

A still further embodiment includes a method for performing photonic quantum computing comprising:
generating at least one single photon pulse from a photon source, wherein at least one photonic qubit is encoded in the at least one single photon pulse;
propagating the at least one single photon pulse in at least one optical storage ring;
using at least one optical switch on the at least one optical storage ring to direct the at least one single photon pulse through at least one beamsplitter and through at least one phase shifter;
directing the at least one single photon pulse to scatter with a single atom source in at least one cavity, wherein the single atom source comprising a atomic qubit; returning the at least one single photon pulse to the at least one optical storage ring;
applying a rotation to the atomic qubit;
performing a projective measurement to the atomic qubit; and teleporting the rotation of the atomic qubit onto the photonic qubit.
   The single atom source is controlled by at least a laser source.

In still yet another embodiment, at least three sets of the teleported rotations are performed.

Still another additional embodiment includes constructing at least one arbitrary single-qubit gate.

A yet further embodiment includes constructing a two-photon entangling gate.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1A illustrates a schematic of a deterministic photonic quantum computer in accordance with an embodiment.

FIG. 1B illustrates a Bloch sphere depiction of the state of a photonic qubit and an operation applied by one pass through the scattering unit in accordance with an embodiment.

FIG. 2 illustrates quantum gate sequence corresponding to one pass of a photon through the scattering unit in accordance with an embodiment.

FIGS. 3A-3I illustrate a series of schematics of a photon passing through the fiber ring and one pass of the photon passing through the scattering unit in accordance with an embodiment.

FIG. 4A illustrates a generic target quantum circuit in accordance with an embodiment.

FIG. 4B illustrates decomposition of the quantum circuit into an equivalent circuit of single-qubit and ca gates in accordance with an embodiment.

FIG. 4C illustrates the circuit of a single-qubit further decomposed into a sequence of scattering interactions in accordance with an embodiment.

FIG. 4D illustrates the controllable elements of the quantum device including the optical switches, cavity laser, and atomic state readout in accordance with an embodiment.

FIG. 5A illustrates output pulse shapes when a cavity with cooperativity driven by a Gaussian input pulse in accordance with an embodiment.

FIG. 5B illustrates shape infidelity and photon leakage probability as a function of cavity cooperativity in accordance with an embodiment.

FIG. 5C illustrates estimated single-qubit circuit depth achievable while maintaining greater than 50% fidelity as a function of cavity cooperativity and photon attenuation per cycle in accordance with an embodiment.

### DETAILED DESCRIPTION OF THE INVENTION

Turning now to the drawings, systems and methods utilizing synthetic dimensions in deterministic photonic quantum computation, are described. Many embodiments provide deterministic photonic quantum computation in a synthetic time dimension. Several embodiments provide deterministic photonic quantum computation in a synthetic time dimension using a single atom. A number of embodiments provide photonic quantum computation using a single coherently controlled atom to indirectly manipulate a many-photon quantum state. In several embodiments, quantum operations applied to the atomic qubit can be teleported onto the photonic qubits via projective measurements. In some embodiments, arbitrary quantum circuits can be compiled into a sequence of teleported gates. In several embodiments, arbitrary single-qubit gates can be deterministically constructed from rotations applied to the atomic qubit and teleported onto the photonic qubits via projective measurements. In a number of embodiments, synthetic time dimensions can negate the need for many identical quantum emitters to be integrated into a photonic circuit. In certain embodiments, the single atom can provide effective all-to-all connectivity between photonic qubits. Many embodiments provide fully deterministic photonic quantum computation. Deterministic photonic quantum computation in accordance with several embodiments does not require single-photon detectors. In many embodiments, two-photon gates can be implemented, and readout of the photonic quantum state can be done using atomic measurements with efficiencies greater than that of photon detectors. Some embodiments provide photonic quantum computing can be robust to experimental imperfections. Several embodiments provide that an error rate per gate is of order 10⁻⁴.

There can be two approaches for implementing multi-photon gates: (i) by projectively measuring a two-photon system augmented with ancillary photons to create an effective interaction, and (ii) by scattering photons against quantum emitters to induce a two-photon interaction. The former approach can also be known as linear optical QC. Linear QC is non-deterministic with a theoretical success probability below 100%, and is in need of huge resource overheads for fault tolerance. The latter approach may allow for deterministic gate operation, but may require unrealistically large numbers of identical quantum emitters to realize sizeable quantum circuits. There has been progress in implementing individual high-fidelity two-photon gates with scattering-based approaches. However, realizing many distinct high-fidelity gates and connecting them to form a quantum circuit can be exponentially more difficult, especially due to poor indistinguishability of solid-state quantum emitters from homogeneous and inhomogeneous broadening. An architecture which uses only a single quantum emitter to implement a large number of distinct quantum gate operations would improve the scalability and experimental feasibility of scattering-based photonic quantum computation.

Previous works on photonic quantum computing include generating time- and frequency-multiplexed 2D cluster states using a single or a pair of quantum emitters, (See, e.g. Pichler, H., et al., Proceedings of the National Academy of Sciences, 2017, 114, 11362-11367; Economou, S. E., et al., Physical Review Letters, 2010, 105, 093601; the disclosures of which are herein incorporated by references), and experimental demonstrations using parametric non-linearities. (See, e.g. Asavanant, W., et al., Science, 2019, 366, 373-376; Larsen, M. V., et al., Science, 2019, 366, 369-372; the disclosures of which are herein incorporated by references). Although 2D cluster states can be a universal resource for quantum computation when combined with measurement, the schemes that prepare these states may only apply a single type of quantum operation to the photonic qubits, and photon detectors with their associated limitations may be required for further processing and state readout. In contrast, many embodiments directly implement the quantum circuit model of quantum computing. Many embodiments can deterministically construct any quantum gate and perform state readout without the need for photon detectors.

Many embodiments provide synthetic dimensions in deterministic photonic quantum computation. Synthetic dimensions can be formed by designing the couplings between states of a system by repurposing the usual geometric dimensions including (but not limited to) space and/or time. Synthetic dimensions can also be formed by designing the couplings between states of a system by augmenting these dimensions with internal degrees of freedom including (but not limited to) frequency, spin, orbital angular momentum, and/or Floquet-induced side bands. Since couplings between states within the synthetic dimensions can be dynamically reconfigured and are not fixed by physical structure, many embodiments can scalably implement lattices with intricate connectivity. Several embodiments can enable multiple photonic qubits to be manipulated in synthetic space without requiring spatially separated structures.

Many embodiments provide deterministic photonic quantum computers in a synthetic time dimension. Some embodiments provide deterministic photonic quantum computers in a synthetic time dimension using a single atom. In many embodiments, deterministic photonic quantum computers can be realized in a synthetic time dimension using a single coherently controlled atom. In certain embodiments, deterministic photonic quantum computers in a synthetic time dimension using a single coherently controlled atom can manipulate an arbitrary photonic state. As can readily be appreciated, any of a variety of synthetic dimensions can be utilized as appropriate to the requirements of specific applications in accordance with various embodiments of the invention.

In several embodiments, deterministic photonic quantum computers can include at least one optical storage ring including (but not limited to) an optical fiber ring coupled with at least one cavity. In some embodiments, fiber optics can have low optical attenuation per unit length. Loss may be a main error source for photonic qubits. The attenuation of fiber rings can be a factor in how many qubits can run in photonic quantum computers without using more complex error correction schemes in accordance with many embodiments. In certain embodiments, a single-mode 1550 nm fiber can have an attenuation of about 0.15 dB/km. A number of embodiments provide minimizing diameter of fiber rings can minimize cycle time and thus loss per cycle, while having enough space for optical qubits. Certain embodiments provide that the size of fiber rings may relate to photon pulse length. The gate mechanisms function well at long and short photon pulse lengths, and a main bottleneck can be how fast the optical switches can actuate. In several embodiments, fiber rings can have a diameter of about 20 cm given optical switches having about 1 ns switching time. Some embodiments provide that a fiber ring which can support N photonic qubits would have about (20 cm*N) in circumference.

Certain embodiments provide that deterministic photonic quantum computers can include at least one optical switch on at least one fiber ring. In a number of embodiments, the deterministic photonic quantum computer can include two optical switches. In some embodiments, photonic qubits can be encoded as trains of single photon pulses generated by a photon source including (but not limited to) a laser. Photonic qubits can counter-propagate through fiber storage rings. The two propagation directions, clockwise and counterclockwise, {| [symbol] [symbol] , | [symbol] [symbol] } can form the computational basis in accordance with certain embodiments. In several embodiments, optical switches can selectively direct photons through a scattering unit to interact with a single atom in a cavity. Optical switches in accordance with certain embodiments can endow the counter-circulating photonic states with a synthetic temporal dimension by allowing coupling between these states. By scattering photons against the atom and subsequently rotating and projectively measuring the atomic state, operations can be teleported onto the photonic qubits in accordance with a number of embodiments. Several embodiments use a single quantum emitter to implement a large number of distinct quantum gate operations. In many embodiments, the operations can be composed to deterministically construct any quantum circuit. Many embodiments provide that readout of the photonic quantum state can be performed without the need for single-photon detectors by sequentially swapping the state of the atom with each photonic qubit.

In some embodiments, qubits can be encoded as trains of single photon pulses counter-propagating through an optical storage ring, where the two propagation directions, clockwise and counterclockwise, may form the computational basis. In certain embodiments, 50:50 beamsplitters can be used to separate photons. As can readily be appreciated, any of a variety of beamsplitters can be utilized as appropriate to the requirements of specific applications in accordance with various embodiments of the invention.

In several embodiments, computing can use qubits where the computational basis can be formed by polarization degrees of freedom. In a number of embodiments, |0> would be vertical and |1> would be horizontal polarization. As can readily be appreciated, any of a variety of computational basis can be utilized as appropriate to the requirements of specific applications in accordance with various embodiments of the invention. In some embodiments, a polarizing beamsplitter can be used to separate photons.

In certain embodiments, the photonic quantum computer can include at least one scattering unit. In many embodiments, a scattering unit can include at least one mirror, coherently-controlled atom in cavity, static beamsplitter, and static phase shifter. The scattering unit may not include the storage ring and photon source.

In several embodiments, coherently controlled atom-cavity system can have a single atom or an atomic emitter. In some embodiments, the cavity can contain a single coherently controlled atomic qubit. Atomic qubits can be coherently controlled by a laser. Many embodiments implement a single atom and/or a single quantum emitter in deterministic photonic quantum computing. Several embodiments implement a single quantum dot. In many embodiments, atoms, quantum emitters, and/or quantum dots may have an energy structure which includes a ∧-shaped three-level structure, where one of the transitions can be resonant with the photon frequency. In certain embodiments, an atom that has a transition near 1550 nm can be implemented. Several embodiments can tune the specific photon frequency and cavity frequency to match a target transition frequency. Examples of atoms that can be used in photonic quantum computing include (but are not limited to): strontium, rubidium, caesium. As can readily be appreciated, any of a variety of atoms can be utilized as appropriate to the requirements of specific applications in accordance with various embodiments of the invention.

Many embodiments provide that the controllable quantum resource can be a single atomic qubit in deterministic photonic quantum computers. Several embodiments provide that all quantum manipulations and measurements of the photonic qubits can be carried out indirectly by operations performed on a single atom. Photonic quantum computers in accordance with some embodiments can reduce the implementation challenges to preparing a single strongly coupled atom-cavity system. In several embodiments, a synthetic time dimension can allow a single atom to serve as the nonlinearity for all quantum gates, negating the need for many identical quantum emitters to be integrated into a photonic circuit, and providing effective all-to-all connectivity between the photonic qubits. In a number of embodiments, photonic quantum computers do not require single-photon detectors. Single-photon detectors can be a major limitation to photonic quantum computing, since detection efficiency η is about 93%. The detection efficiency of a single-photon detector can be a prohibitively low value as the measurement fidelity of an n-photon state scales as ηⁿ. Many embodiments provide that measurement of the atomic state can be performed with near 100% efficiency using the quantum jump technique, greatly improving the scalability of deterministic photonic quantum computers.

Many embodiments provide deterministic photonic quantum computing using qudits. Qudits are “d-level” qubits. In several embodiments, deterministic photonic quantum computing implement qudits with four basis states using polarization as an additional degree of freedom. In some embodiments, the photonic qudits could have one of four values (00, 01, 10, 11). In certain embodiments, the first digit can be determined by the propagation direction within the ring (clockwise or counter clockwise). In a number of embodiments, the second digit can be determined by the polarization of the photon (vertical or horizontal). The gate mechanism could be modified to work in this expanded basis by adding polarizing beamsplitters to the lower waveguide before the cavity in accordance with many embodiments. In some embodiments, deterministic photonic quantum computing could be further extended to 2\hat{ }d level qudits by adding additional degrees of freedom including (but not limited to) orbital angular momentum.

In many embodiments, deterministic photonic quantum computers can achieve spatial multiplexing by using an array of equally sized rings. In several embodiments, the array of equally sized rings have switch junctions. In some embodiments, switch junctions can direct photons from any ring to interact with an atom-cavity system and return the photons to their original ring. Multiplexing photonic quantum computing systems in accordance with many embodiments would allow for more qubits to be stored in the rings while keeping the optical cycle length constant, minimizing attenuation losses.

Many embodiments implement multiplexing several photon pulses in a single ring in the same time bin which can be distinguished by using filters to separate the desired degrees of freedom including (but not limited to) polarization and/or orbital angular momentum. In several embodiments, vertically and horizontally polarized photons occupying the same time bin can be separated with a polarizing beamsplitter. Some embodiments can allow for more qubits to be contained within a smaller fiber ring, reducing cycle time and thus losses due to optical attenuation.

In many embodiments, generalizations of the deterministic photonic quantum computing to synthetic dimensions other than time multiplexing could further improve the scalability. Instead of using counter-propagating optical modes, several embodiments could encode each qubit in the polarization basis. With suitable design of the atom-cavity interacting system, frequency or angular momentum modes could be used as an alternative synthetic dimension. Some embodiments provide the possibility to study quantum many-body physics of interacting Hamiltonians in synthetic space, which is difficult to realize in purely photonic platforms without the strong single-photon nonlinearity of the atom.

Systems and methods for deterministic photonic quantum computing in accordance with various embodiments of the invention are discussed in further detail below.

### Deterministic Photonic Quantum Computers

Systems and methods for deterministic photonic quantum computers in a synthetic time dimension in accordance with various embodiments of the invention are discussed further below. Many embodiments provide deterministic photonic quantum computers in a synthetic time dimension using a single atom. In many embodiments, qubits can be encoded as trains of single photon pulses counter-propagating through an optical storage ring, where the two propagation directions, clockwise and counterclockwise, {| [symbol] [symbol] , | [symbol] [symbol] } form the computational basis. In some embodiments, a single-photon source can inject photon pulses into the ring. In several embodiments, each photon can be spectrally narrow about a carrier frequency ω_{c}, has a pulse width τ, and occupies its own time bin with temporal spacing Δt>>τ. In a number of embodiments, the photon source need not be deterministic as long as the time bin of each photon can be resolved. In some embodiments, a dedicated single-photon source may not be needed, as the atom-cavity system could be used as the source by using the control laser to excite the atom.

In many embodiments, the storage ring may contain a pair of asymmetrically placed optical switches, which can selectively direct photons from the ring through a static 50:50 beamsplitter and π/4 phase shifter and into a pair of waveguides. One of the waveguides can be coupled to a cavity containing a single atom with a ∧-shaped three-level energy structure. The atom has non-degenerate ground states |g₀ [symbol] and |g₁ [symbol] and an excited state |e [symbol] , and the |g₁ [symbol] ↔|e [symbol] transition at frequency Ω₁ is resonant with cavity mode frequency and photon carrier frequency ω_{c}. The atom can be coherently controlled by a laser which applies rotations between |g [symbol] and |g₁ [symbol] , and its state can be measured in the |g₀ [symbol] , |g₁ [symbol] basis. In many embodiments, a subsystem including mirrors, coherently-controlled atom in cavity, static 50:50 beamsplitter, and static π/4 phase shifter can be referred as the “scattering unit”. The scattering unit does not include the storage ring and photon source. The round-trip optical path length through the scattering unit can be matched to the path length around the storage ring so that a photon returns to its original time bin after passing through the scattering unit.

In several embodiments, after a photon scatters against the atom and is returned to the storage ring, a rotation can be applied to the state of the atomic qubit and a projective measurement can be performed, teleporting the rotation onto the photonic qubit. By composing three of these teleported rotations, arbitrary single-qubit gates can be deterministically constructed in accordance with some embodiments. A controlled phase-flip (cat) gate between two photons can also be constructed with a similar process, enabling universal quantum computation. In many embodiments, readout of the final quantum state can be performed without the need for single-photon detectors by sequentially swapping the state of the atom with each photonic qubit.

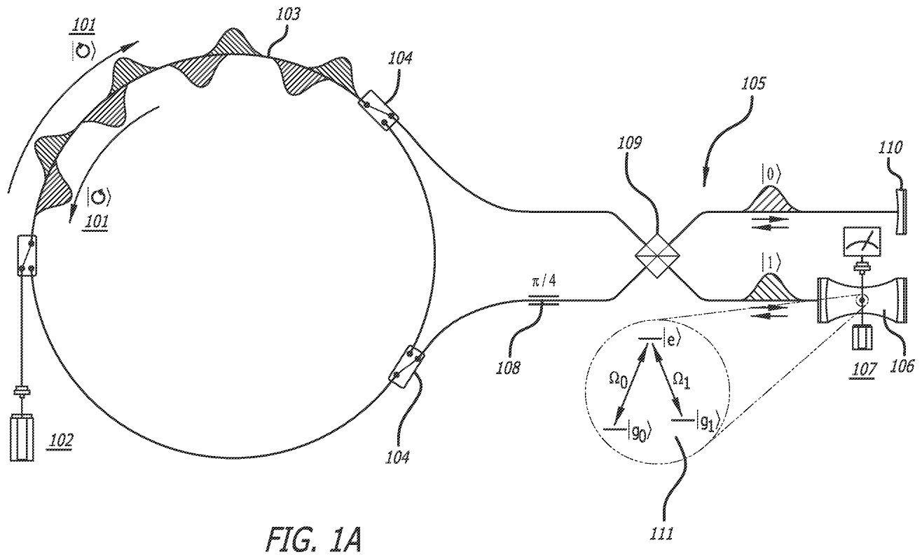

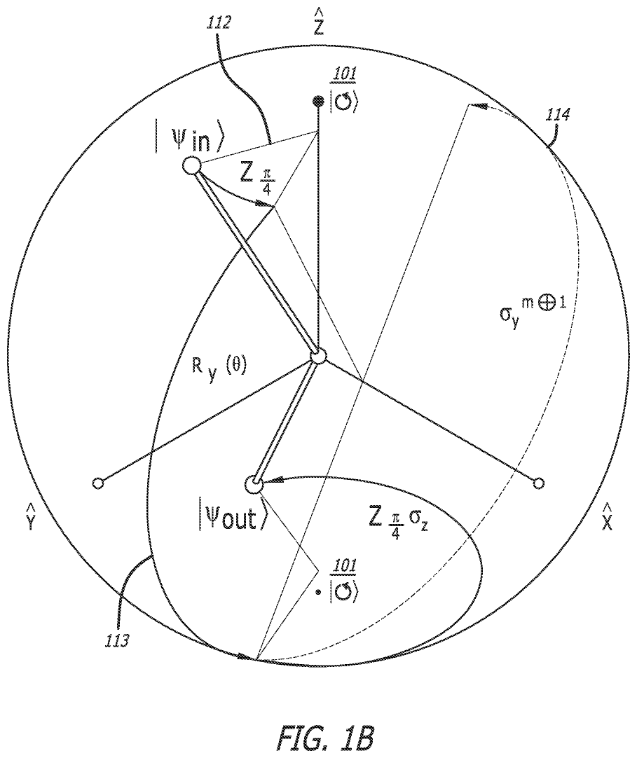

In many embodiments, deterministic photonic quantum computers use synthetic temporal dimension from optical switch coupling. Several embodiments provide that a single physical system can be reused for all gates. In some embodiments, the photons are not directly manipulated or measured, and atoms perform all operations. A deterministic photonic quantum computer in accordance with an embodiment of the invention is illustrated in FIGS. 1A-1B. FIG. 1A illustrates a setup of the photonic quantum computer. Qubits can be time-indexed, counter-propagating single photon pulses (101). The two clockwise and counterclockwise propagation directions, {| [symbol] [symbol] , | [symbol] [symbol] } form the computational basis {|0 [symbol] , |1 [symbol] }. The time bin size Δt, can be much greater than the photon pulse length τ. The photon frequency ω can be much greater than 1/τ. A single-photon source (102) can inject photon pulses into a fiber storage ring (103). The fiber ring can have a length (L) equals to nΔt, which can support n photonic qubits. Photonic qubits (101) counter-propagate through a fiber storage ring (103) and optical switches (104) can selectively direct photons through a scattering unit (105) to interact with an atom in a cavity (106) which is coherently controlled by a laser (107). The optical switches (104) can be asymmetrically placed in the storage ring (103). The high-speed optical switches can allow for controlled scattering of photons in desired time bins. The time bins can be made larger to accommodate lower switching speed of the optical switches. The optical switches (104) can selectively direct photons (101) from the ring (103) through a static 50:50 beamsplitter (109) and π/4 phase shifter (108) and into a pair of waveguides (110). One of the waveguides (110) can be coupled to a cavity (106) containing a single atom with a ∧-shaped three-level energy structure (111). Photon in the top waveguide (110) hits mirror, reflected with no phase shift. Photon in the bottom waveguide (110) interacts with the atom. The atom has non-degenerate ground states |g₀ [symbol] and |g₁ [symbol] and an excited state |e [symbol] , and the |g₁ [symbol] ↔|e [symbol] transition at frequency Ω₁ is resonant with cavity mode frequency and photon carrier frequency ωc. The atom can be coherently controlled by a laser (107) which applies rotations between |g₀ [symbol] and |g₁ [symbol] , and its state can be measured in the |g₀ [symbol] , |g₁ [symbol] basis. The energy structure of the atom (111) illustrates Ω₁ is resonant with the cavity mode and photon carrier frequency, while Ω₀ is far-detuned.

FIG. 1B illustrates Bloch sphere of the state of a photonic qubit (101) in the {| [symbol] [symbol] , | [symbol] [symbol] } basis and an operation applied by one pass through the scattering unit. The rotations about \hat{z} by fixed angles (112) can be applied by the phase shifter (108) and beamsplitter (109), while the rotation about 0.9 by a controllable angle θ (113) can be applied to the atom using the cavity laser (107). Projectively measuring the atom can teleport this rotation onto the photon, but may overshoot the target angle θ by π (114) depending on the measurement outcome m. This operation is a universal single-qubit primitive: by composing several of these operations and adapting subsequent rotation angles based on measurement outcomes, arbitrary single-qubit gates can be deterministically constructed.

While various systems for photonic quantum computers using a synthetic time dimension are described above with reference to FIGS. 1A and 1B, any variety of photonic quantum computers can be utilized as appropriate to the requirements of specific applications in accordance with various embodiments of the invention. For the purposes of illustrates a specific example of gate teleporting rotation operation in accordance with various embodiments of the invention are discussed further below.

### Gate Teleportation Mechanisms—Teleporting Rotation Operations

Many embodiments provide gate teleportation mechanisms by which a rotation gate may be teleported onto a photonic qubit. Several embodiments provide that by composing teleported rotations, arbitrary single-qubit gates may be constructed. In some embodiments, a rotation to photon j, which occupies time bin ti and is circulating in the storage ring in state |ψᵢₙ [symbol] =α| [symbol] [symbol] +|β [symbol] [symbol] , where | [symbol] [symbol] and | [symbol] [symbol] denote the two counter-circulating states. While the optical switches are in the “closed” state, photons remain inside the storage ring; to operate on photon j, the switches can be “open” at time tⱼ−Δ t/2 and closed again at tⱼ+Δt/2 to direct photon j into the scattering unit. The photon passes through a π/4 phase shifter, which can apply (up to a global phase) a

$${Z}_{π / 4} ≡ {R}_{z ( π / 4 )} = ( \begin{matrix}{e}^{- i π / 8} & 0 \\ 0 & {e}^{i π / 8}\end{matrix} )$$

rotation, and a 50:50 beamsplitter, which applies

$$B = \frac{1}{\sqrt{2}} ( \begin{matrix}1 & i \\ i & 1\end{matrix} ) .$$

Before interacting with the atom, the photon is a superposition of modes in the top and bottom waveguides. The spatial modes can be labeled as |0 [symbol] and |1 [symbol] , respectively. The basis states of the ring and scattering unit can be related via the unitary transformation {|0 [symbol] , |1 [symbol] }=BZ_{π/4} {| [symbol] [symbol] , | [symbol] [symbol] }.

The |0 [symbol] component of the photon state can be reflected by a mirror in the top waveguide, imparting a π phase shift, while the |1 [symbol] component undergoes a cavity-assisted interaction with the atom in the bottom waveguide, which is initialized in the state

$$\vert + 〉 ≡ \frac{1}{\sqrt{2}} ( \vert {g}_{0} 〉 + \vert {g}_{1} 〉 ) .$$

The |g₁ [symbol] ↔|e [symbol] transition frequency Ω₁ is resonant with the cavity mode and photon frequency ω_{c}, while the |g₀ [symbol] ↔|e [symbol] frequency Ω₀ is far-detuned. Thus, relative to the phase of the |0 [symbol] mode, a π phase shift is applied to the |1 [symbol] ⊗|g₁ [symbol] component of the |photon [symbol] ⊗|atom [symbol] quantum state, implementing the unitary transformation corresponding to a controlled-Z gate between the atom and the photon, cσ_{z}= [symbol] . After scattering, the photon passes back through the beamsplitter and phase shifter and is returned to the storage ring. The joint state |Φ [symbol] of the photon-atom system after a round trip through the scattering unit is:

|Φ [symbol] =(Z_{π/4}B⊗1)cσ_{z}(BZ_{π/4}⊗1)(|ψᵢₙ [symbol] ⊗|+ [symbol] ). (1)

After the photon has returned to the storage ring, a rotation Rₓ(−θ)=exp(iσₓθ/2) can be applied to the atomic qubit. Finally, a projective measurement of the atomic state in the |g₀ [symbol] , |g₁ [symbol] basis is performed, obtaining a bit mϵ{0,1}. This atomic measurement projects the state of the photonic qubit to:

$$\begin{matrix}\vert {ψ}_{out} 〉 = {Z}_{π / 4} {{σ}_{z} ( - {σ}_{y} )}^{m ⊕ 1} {R}_{y} ( θ ) {Z}_{π / 4} \vert {ψ}_{in} 〉 \\ = {i}^{m} {Z}_{5 π / 4} {R}_{y} ( θ + π ( m ⊕ 1 ) ) {Z}_{π / 4} \vert {ψ}_{in} 〉 ,\end{matrix} \qquad ( 2 )$$

where R_{y}(θ)=exp(iσ_{y}θ/2) and m⊗1 denotes addition modulo 2. Thus, the measurement teleports the Rₓ(θ) rotation of the atom to the R_{y}(θ) or R_{y}(θ+π) rotation of the photon, depending on m.

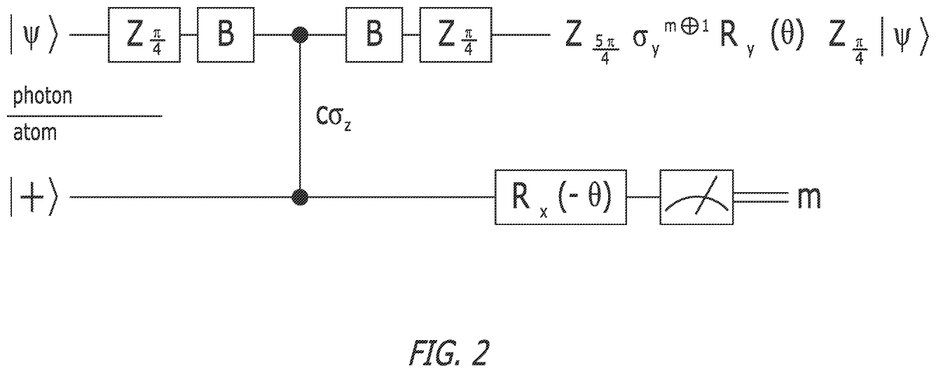

A quantum gate sequence corresponding to one pass of a photon through the scattering unit in accordance with an embodiment of the invention is illustrated in FIG. 2. The projective measurement teleports the rotation applied to the atomic qubit onto the photonic qubit. Gate teleportation enables only measuring the atom but not the photonic qubit.

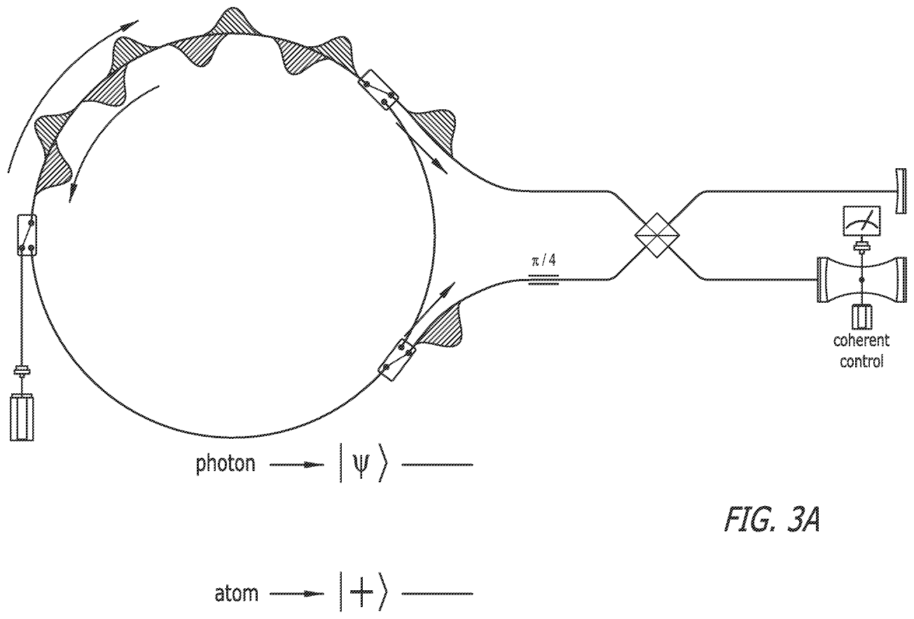

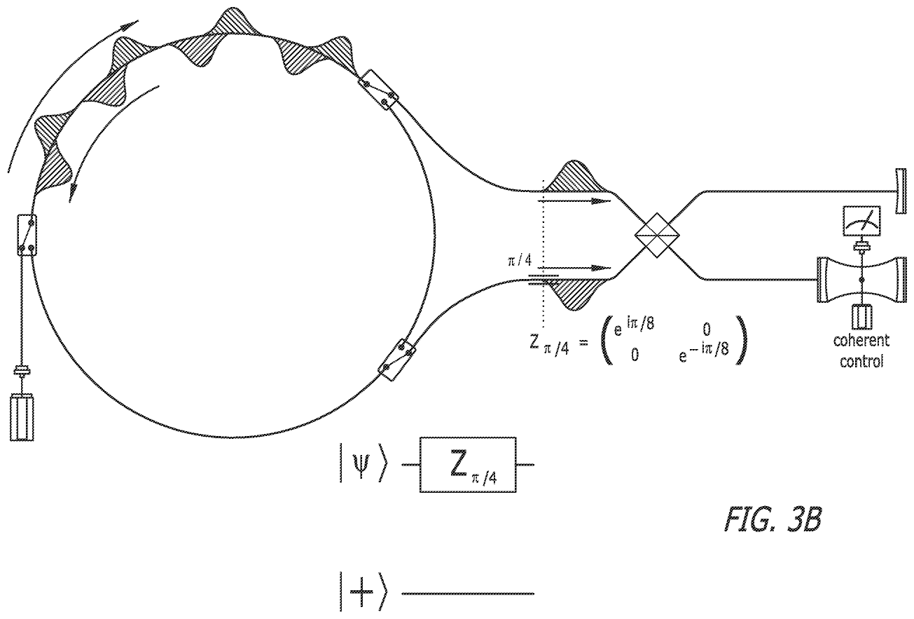

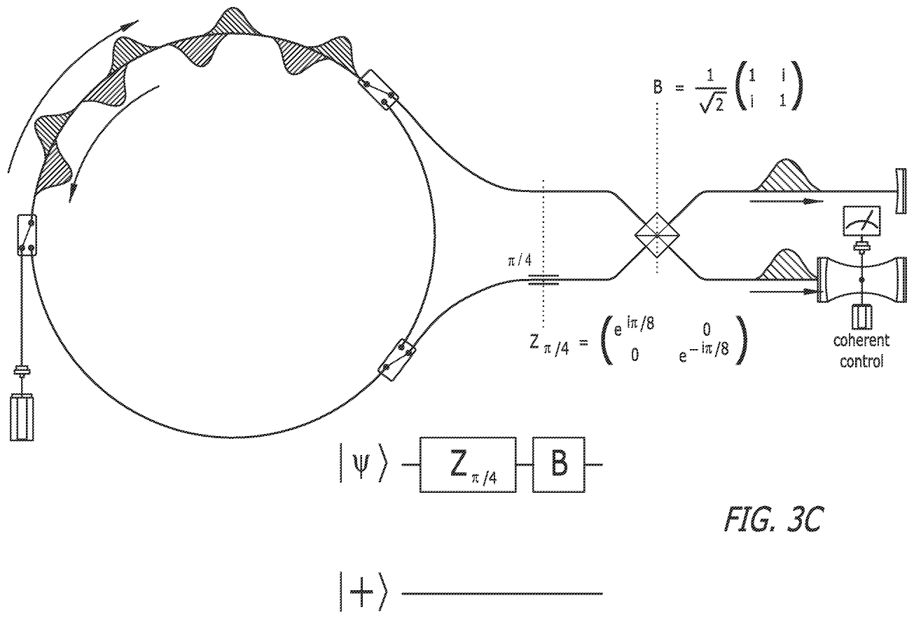

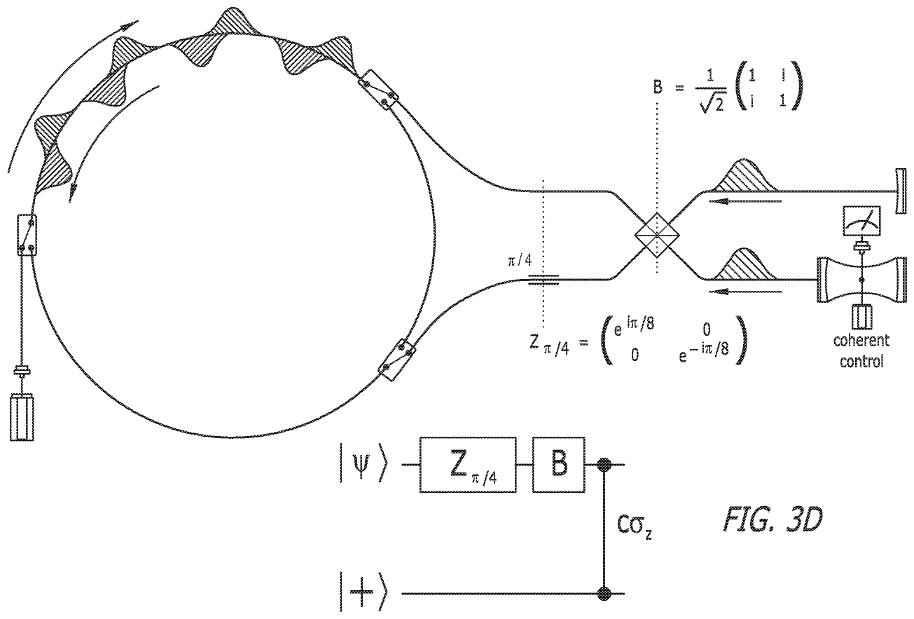

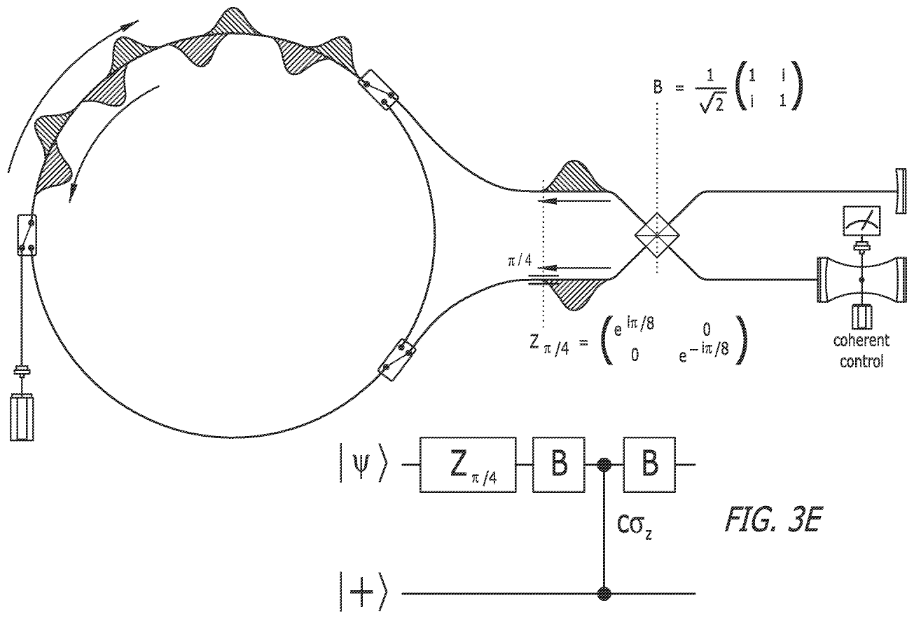

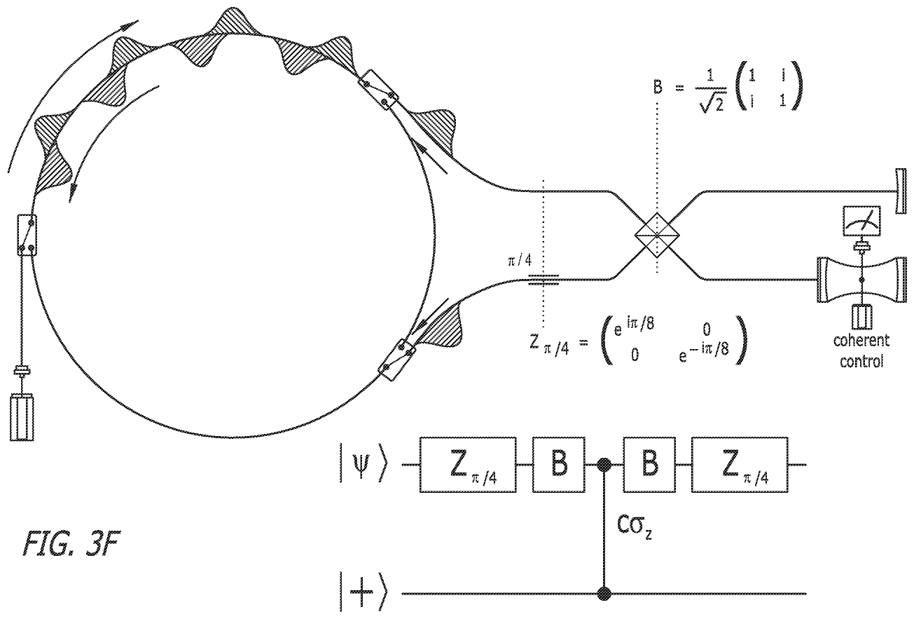

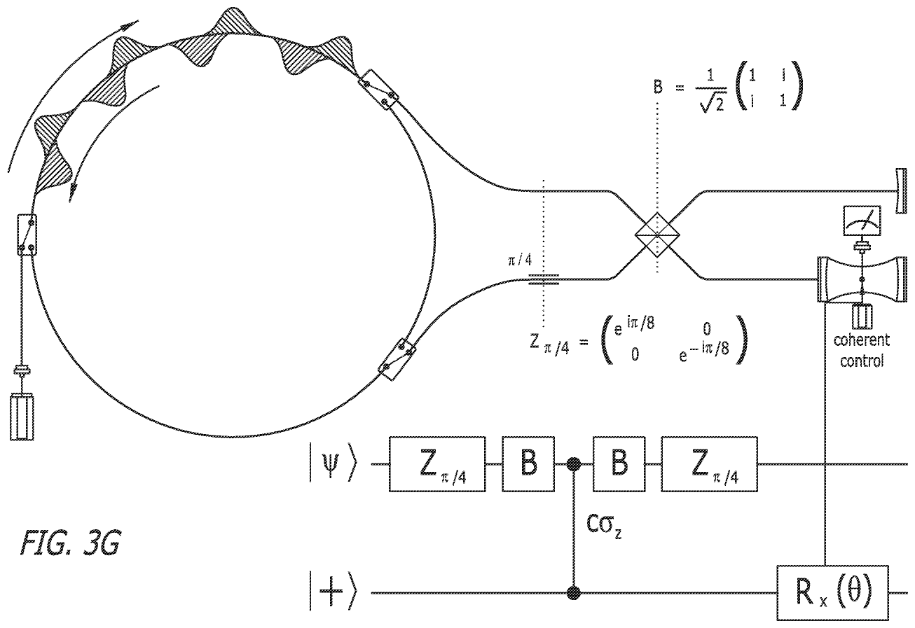

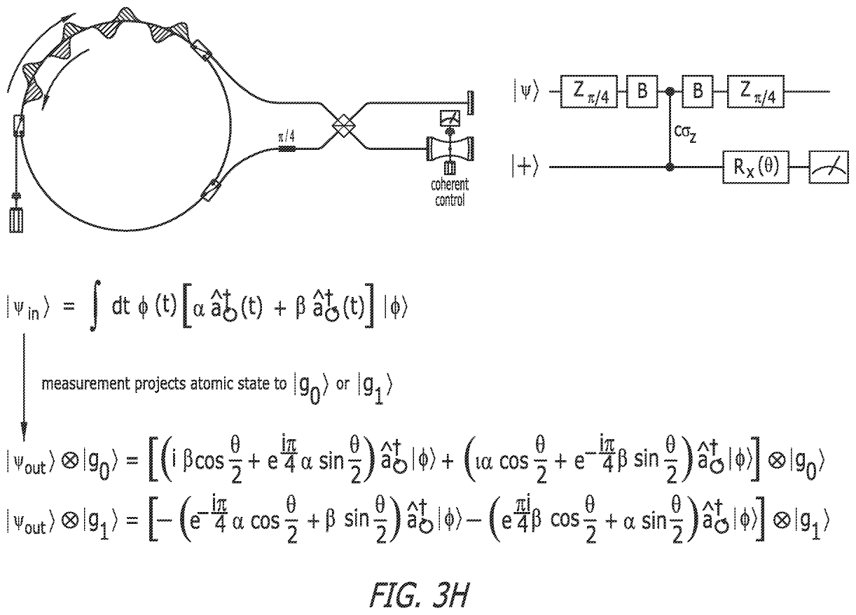

A sequence of gate teleportation mechanism in accordance with an embodiment of the invention is illustrated in FIGS. 3A-3I. FIG. 3A illustrates single photon pulse counter propagate the fiber ring. The photon state can be represented as |0 [symbol] , and the atom state can be represented as |+ [symbol] .

FIG. 3B illustrates the photon passes through a π/4 phase shifter, which can apply a

$${Z}_{π / 4} ≡ {R}_{z ( π / 4 )} = ( \begin{matrix}{e}^{- i π / 8} & 0 \\ 0 & {e}^{i π / 8}\end{matrix} )$$

rotation. FIG. 3C illustrates the photon passes through a beamsplitter, which applies

$$B = \frac{1}{\sqrt{2}} ( \begin{matrix}1 & i \\ i & 1\end{matrix} ) .$$

Before interacting with the atom, the photon is a superposition of modes in the top and bottom waveguides.

In FIG. 3D, the basis states of the ring and scattering unit can be related via the unitary transformation {|0 [symbol] , |1 [symbol] }=BZ_{π/4}{| [symbol] [symbol] ), | [symbol] [symbol] }. The |0 [symbol] component of the photon state can be reflected by a mirror in the top waveguide, imparting a π phase shift, while the |1 [symbol] component undergoes a cavity-assisted interaction with the atom in the bottom waveguide, which is initialized in the state

$$\vert + 〉 ≡ \frac{1}{\sqrt{2}} ( \vert {g}_{0} 〉 + \vert {g}_{1} 〉 ) .$$

The |g₁ [symbol] ↔|e [symbol] transition frequency Ω₁ is resonant with the cavity mode and photon frequency ω_{c}, while the |g₀ [symbol] ↔|e [symbol] frequency Ω₀ is far-detuned. Thus, relative to the phase of the |0 [symbol] mode, a π phase shift is applied to the |1 [symbol] ⊗|g₁ [symbol] component of the |photon [symbol] ⊗|atom [symbol] quantum state, implementing the unitary transformation corresponding to a controlled-Z gate between the atom and the photon, cσ_{z}=e^{iπ|1} [symbol] ^{(1|⊗|g}^{₁} [symbol] ^{g}^{₁}.

FIG. 3E illustrates after scattering, the photon passes back through the beamsplitter. FIG. 3F illustrates that the photon passes back through the phase shifter after passing through the beamsplitter, and is returned to the storage ring.

FIG. 3G illustrates that a rotation Rₓ(−θ)=exp(iσₓθ/2) can be applied to the atomic qubit after the photon has returned to the storage ring.

FIG. 3H illustrates a projective measurement can project the atomic states to |g₀ [symbol] or |g₁ [symbol] basis. FIG. 3I illustrates a projective measurement of the atomic state in the |g₀ [symbol] , |g₁ [symbol] basis can be performed at last, obtaining a bit mϵ{0,1}.

Several embodiments provide that the teleportation scheme can be an inversion of the paradigm of teleportation-based quantum computing. In both cases, the original data qubit may be entangled with an ancilla using a cσ_{z} operation. Instead of rotating and measuring the data qubit to teleport the modified state onto the ancilla, many embodiments can rotate and measure the ancilla (the atom) to teleport a rotation onto the data qubit (the photon).

While various processes for gate teleporting rotation operations of photonic quantum computers using a synthetic time dimension are described above with reference to FIG. 2 and FIGS. 3A-3I, any variety of processes that utilize gate teleporting rotations can be utilized as appropriate to the requirements of specific applications in accordance with various embodiments of the invention. For the purposes of illustrates a specific example of constructing single-qubit gate in accordance with various embodiments of the invention are discussed further below.

### Gate Teleportation Mechanisms—Constructing Arbitrary Single-Qubit Gates

Many embodiments provide that the teleported gate operation of Eq. 2 may be sufficient to construct arbitrary single-qubit gates. The purpose of the Z_{π/4} operations performed by the phase shifter can be to rotate the basis in which the R_{y}(θ) gate is applied. Two passes of a photon through the phase shifter corresponds to a rotation on the Bloch sphere about \hat{z} by 90°; this change of basis causes a subsequent R_{y}(θ) to effectively rotate about \hat{x}. An additional two passes through the phase shifter rotates 2 to −ŷ, allowing R_{y}(θ) to act about 9 again. The goal is to construct an operation that has the form U=R_{y}(θ₃)Rₓ(θ₂)R_{y}(θ₁), which may be sufficient to implement any single-qubit gate up to an overall phase decomposed via Euler angles.

Consider a sequence of three teleported rotation gates (Eq. 2) about angles θ₁, θ₂, θ₃ which yield measurement results m₁, m₂, m₃. As the target operator U is built up with these successive rotations, the outcomes m₁, m₂, m₃ can result in extraneous Pauli gates between rotations which effectively offset the target angles θ₁, θ₂, θ₃ by π, as in the second line of Eq. 2. This can be equivalent to constructing an arbitrary rotation in 3D space using only fixed 90° rotations about \hat{z}, together with variable rotations about ŷ which may overshoot by π.

Using a concept from measurement-based quantum computation, many embodiments apply rotations to the atomic qubit about adaptive angles of θ₂(m₁) and θ₃(m₂, m₁), each of which depends on the results of the preceding measurements. This can allow to propagate the Pauli errors from the middle of the gate to the front and consolidate them as a single error term. The sequence of three rotations performed in this adaptive basis thus implements the operation:

U=ε(m₃,m₂,m₁)*Z_{π/4}R_{y}(θ₃(m₂,m₁))Rₓ(θ₂(m₁))R_{y}(θ₁)Z_{π/4}. (3)

where the rotations can be implicitly programmed to implement U in the basis rotated by Z_{π/4} and where the error term ε(m₃, m₂, m₁) is σₓ, σ_{y}, or σ_{z} up to a global phase. This error term ε can then either (i) be implicitly removed by programming a subsequent gate U′ to instead implement U′ε¹ or (ii) be explicitly removed by scattering the photon against the atom initialized in the non-interacting |g₀ [symbol] state or in the fully-interacting |g₁ [symbol] state, applying σₓ or σ_{y}, respectively.

While various processes for constructing single-qubit gates of deterministic photonic quantum computers are described above, any variety of processes that construct single-qubit gates can be utilized as appropriate to the requirements of specific applications in accordance with various embodiments of the invention. For the purposes of illustrates a specific example of constructing two photon gate in accordance with various embodiments of the invention are discussed further below.

### Gate Teleportation Mechanisms—Two Photon Gates

Many embodiments provide a two-photon entangling gate for universal computation in addition to single-qubit gates. A controlled phase-flip gate ca, between two photonic qubits j and k can be constructed through a sequence of three scattering interactions. However, the beamsplitter and phase shifter, which are used to implement the single-qubit gates, only allow the application of operations of the form shown in Eq. 1 to the photon-atom system with each pass of a photon through the scattering unit.

Several embodiments may terminate with a measurement on the atom. Some embodiments denote the operation applied to the photon-atom state by a pass of photon j through the scattering unit interacting with the atom a as:

ζ≡(Z_{π/4}B)^{j}cσ_{z}^{ja}(BZ_{π/4})^{j}. (4)

To implement cσ_{z}^{jk} between photons j and k, certain embodiments pass photon j through the scattering unit, then k, then j again, separated by R_{y}(+π/2) rotations applied to the atom. This can result in the state:

ζ^{ja}R_{y}^{a}(π/2)ζ^{ka}R_{y}^{a}(−π/2)ζ^{ja}(|ψⱼₖ [symbol] ⊗|+ [symbol] ), (5)

where |ψⱼₖ [symbol] is the arbitrary state of photons j and k and where the atom is initialized to |+ [symbol] . After this scattering sequence, the state of the atom can be measured, which projects the two-photon state to:

(Z_{π/4}B⊗Z_{π/4}B)(BZ₍₋₁₎_{^{m}}_{/2}B⊗1)×cσ_{z}^{jk}×(BZ_{π/4}⊗Z_{π/4}B)|ψⱼₖ [symbol] , (6)

where the extraneous single qubit terms BZ_{π/4}, Z_{π/4}B, and BZ₍₋₁₎_{^{m}}_{π/2}B are artifacts of the photons passing through the beamsplitter and phase shifter. These extra gates may not be problematic: when constructing a circuit from single-qubit gates and cat, they may be removed by programming previous and subsequent single-qubit gates to include the inverse gates.

Many embodiments provide arbitrary single-qubit gates and a two-photon cσ_{z} gate. Some embodiments comprise a universal gate set and the device can perform any quantum computation.

While various processes for two photon gates of photonic quantum computers are described above, any variety of processes that construct two photon gates can be utilized as appropriate to the requirements of specific applications in accordance with various embodiments of the invention. For the purposes of illustrates a specific example of circuit compilation in accordance with various embodiments of the invention are discussed further below.

### Gate Teleportation Mechanisms—Arbitrary Circuit Compilation

To implement an arbitrary n-qubit operator UϵU(2ⁿ), many embodiments provide a three-step circuit compilation process. First, decompose U into a sequence of single-qubit gates and cσ_{z} operations. This can be done using the U(2ⁿ) operator preparation with an additional [symbol] (n) speedup, as this scheme has all-to-all instead of nearest-neighbor connectivity between qubits. Second, represent each cσ_{z} as in Eq. 6 and decompose each single-qubit gate via Euler angles into rotations which may be teleported onto the photonic qubits. Finally, use a classical control system to modify the adaptive rotations which are applied to the atomic qubit based on the measurement outcomes during operation and to explicitly correct for ε Pauli errors when necessary.

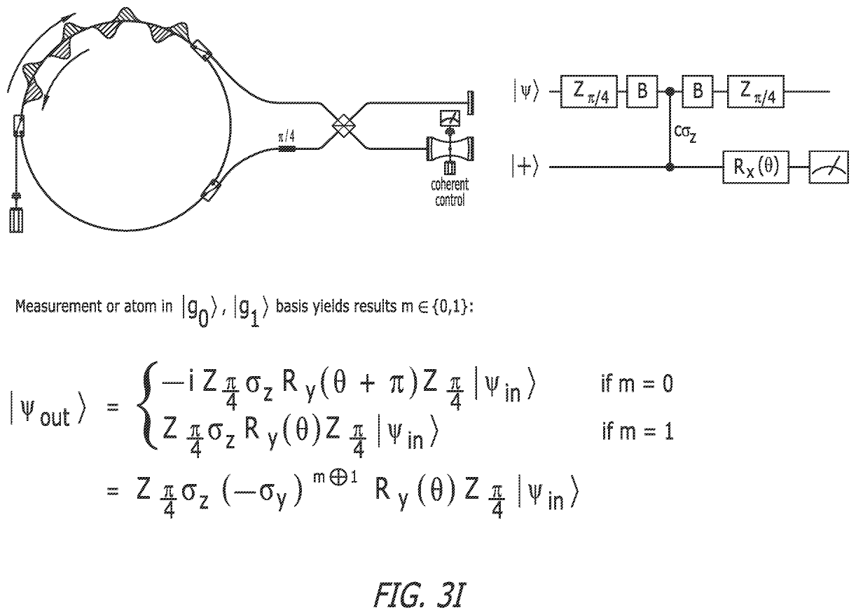

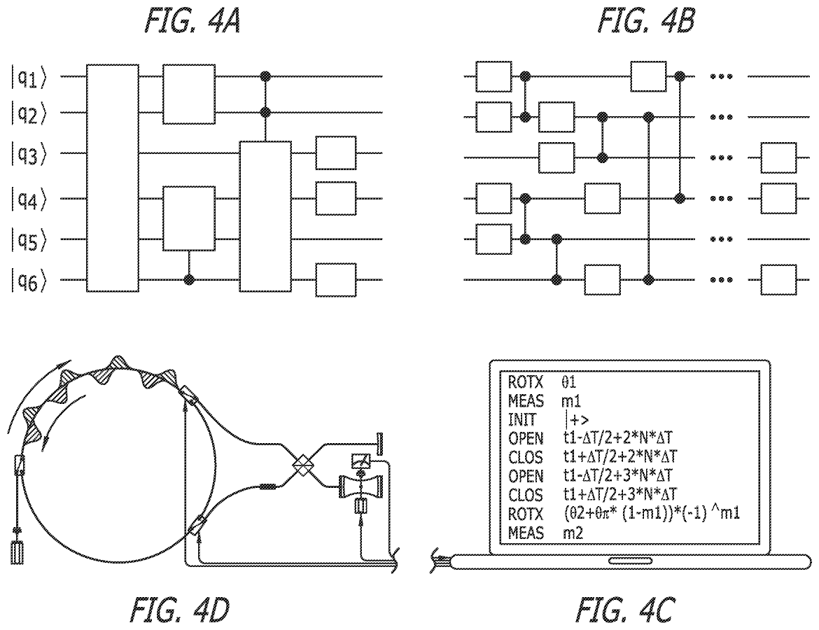

A schematic of compiling a quantum circuit into an instruction sequence to be performed on the device in accordance with an embodiment is illustrated in FIGS. 4A-4D. FIG. 4A illustrates a generic target quantum circuit. FIG. 4B illustrates decomposition of the quantum circuit into an equivalent circuit of single-qubit and cσ_{z} gates. FIG. 4C illustrates the circuit can be further decomposed into a sequence of scattering interactions. This sequence can be assembled on a classical computer into an instruction set with six distinct primitives which correspond to physical actions. FIG. 4D illustrates the controllable elements of the quantum device including the optical switches, cavity laser, and atomic state readout.

While various processes for arbitrary circuit compilation of photonic quantum computers are described above, any variety of processes that construct arbitrary circuit compilation can be utilized as appropriate to the requirements of specific applications in accordance with various embodiments of the invention. For the purposes of illustrates a specific example of quantum state readout in accordance with various embodiments of the invention are discussed further below.

### Gate Teleportation Mechanisms—Quantum State Readout

After applying the quantum operation using the circuit compilation, the state of the photonic qubits can be measured to obtain a classical result in accordance with several embodiments. This can be done without single photon detectors by sequentially swapping the quantum states of each photonic qubit with that of the atom and repeatedly measuring the atomic state in accordance with many embodiments. Single photon detectors have limited detection efficiencies. To perform this SWAP operation, several embodiments scatter the desired photonic qubit j against the atom three times. Between scattering operations, the rotation R_{y} (π/2)Rₓ(π) can be applied to the atomic qubit. Denoting this rotation as ρ^{a} and using ζ^{ja} as defined in Eq. 4, it can be verified that

$${( {BZ}_{π / 4} )}^{j} {ζ}^{ja} {ρ}^{a} {ζ}^{ja} {ρ}^{a} {{ζ}^{ja} ( {Z}_{π / 4} B )}^{j} = {e}^{i π} ( \begin{matrix}1 & 0 & 0 & 0 \\ 0 & 0 & 1 & 0 \\ 0 & 1 & 0 & 0 \\ 0 & 0 & 0 & 1\end{matrix} ) , \qquad ( 7 )$$

which is the SWAP operation up to a factor of −1. (BZ_{π/4})^{j} and (Z_{π/4}B)^{j} are the operations applied to photon j on the outgoing and return trip from the scattering unit respectively.

While various processes for quantum state readout of photonic quantum computers are described above, any variety of processes that read quantum states can be utilized as appropriate to the requirements of specific applications in accordance with various embodiments of the invention.

### EXEMPLARY EMBODIMENTS

Although specific embodiments of systems and methods are discussed in the following sections, it will be understood that these embodiments are provided as exemplary and are not intended to be limiting.

### Example 1: Imperfection Analysis

Many embodiments provide analysis of the performance of deterministic photonic quantum computing in the presence of experimental imperfections. The main sources of error for photonic quantum computers can be grouped into three classes: (i) deformation of the input pulse shape after scattering off the atom-cavity system, (ii) atomic spontaneous emission loss, and (iii) photon leakage due to attenuation and insertion loss while propagating through the storage ring and optical switches.

In several embodiments, the cavity mode frequency ω_{c} can be assumed exactly resonant with the atom |g₁ [symbol] ↔|e [symbol] transition frequency Ω₁, since the detuning can be calibrated to be zero in both free-space and nanophotonic system. In some embodiments, rotations of the atomic state using the cavity laser and measurement of the state can be done with fidelity [symbol] ≈1, as both processes can have infidelities significantly lower than the error sources listed above. For simulations, a photon pulse width of τ=100/K, a time range T=500/κ, and compute cooperativity with fixed γₛ=κ/5 can be used. The parameters are applied in sample cavity setups and result in a temporal bin size of order 100 nanoseconds for κ/2π˜1 GHz.

Several embodiments solve the single-photon transport problem of the coupled atom-cavity-waveguide system and obtain the output pulse φₒᵤₜ(t) when the system is driven by an input pulse φᵢₙ(t). This treatment captures the full quantum mechanical response of the system to a single-photon input Fock state for an arbitrary initialization of the atom without making the semiclassical assumption of a weak coherent input state.

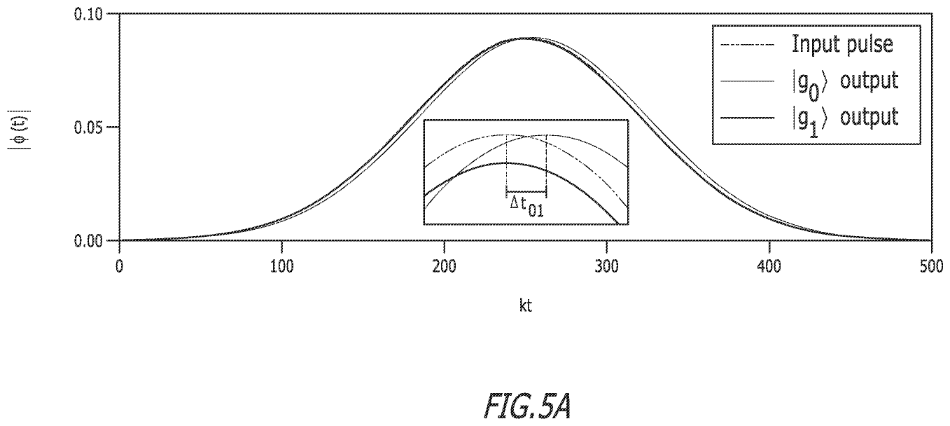

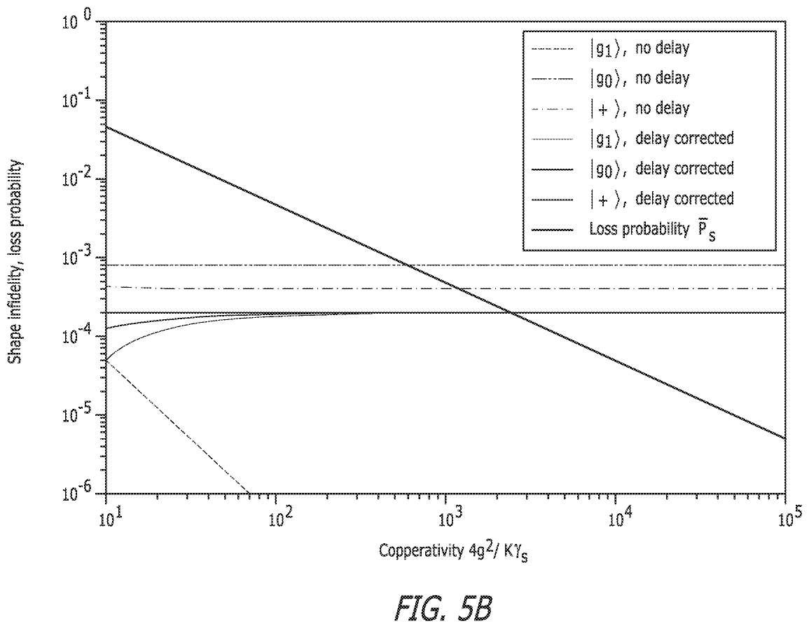

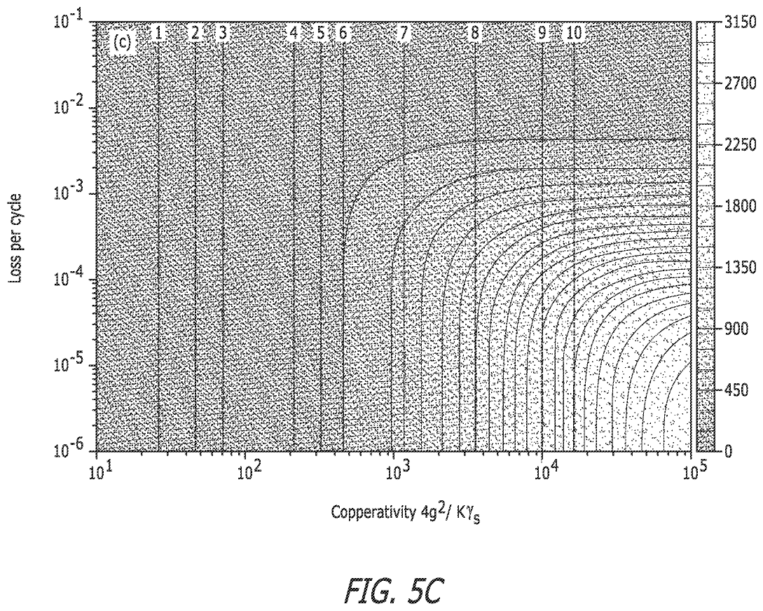

The output pulse shapes for a single-photon Gaussian input pulse when the atom is initialized in states |g₀ [symbol] or |g₁ [symbol] in accordance with an embodiment is illustrated in FIG. 5A. In FIG. 5A, output pulse shapes for |g₀ [symbol] and |g₁ [symbol] initialization when a cavity with cooperativity C=180 is driven by a Gaussian input pulse. The inset highlights the behavior near maximum: the |g₀ [symbol] output pulse is delayed and the |g₁ [symbol] output has reduced amplitude. For the |g₀ [symbol] initialization, the response can be identical to an empty cavity, since the |g₁ [symbol] ↔|e [symbol] transition is far-detuned from the cavity resonant frequency. In this case, the output pulse is slightly delayed from the input pulse. For the |g₁ [symbol] initialization, the photon is directly reflected from the front mirror of the cavity since the dressed cavity modes are well-separated in the strong coupling limit from the input photon frequency by the vacuum Rabi splitting, so the delay is minimal. The difference in the delays of the |g₀ [symbol] and |g₁ [symbol] scatterings can be denoted as Δt₀₁. The pulse shape fidelity [symbol] ₛₕₐₚₑ as the overlap integral of the output pulse with the input pulse after both pulses have been normalized to have unit area, and the pulse shape infidelity is 1− [symbol] ₛₕₐₚₑ. This quantity may describe mismatch of the shapes of the input and output pulses, not mismatch of the pulse areas; the infidelity due to photon loss can be computed as a separate quantity.

Shape infidelity and photon leakage probability as a function of cavity cooperativity in accordance with an embodiment is illustrated in FIG. 5B. In FIG. 5B, the shape infidelity of various states as a function of the single-atom cavity cooperativity C=4g²2/κγₛ is plotted, where κ is the decay rate of the cavity into the waveguide, g is the atom-cavity coupling strength, and γₛ is the atomic spontaneous emission rate. The pulse shape infidelity from scattering off the |g₁ [symbol] state decreases to negligible values as C increases, while the infidelity of |g₀ [symbol] reaches an asymptote at 8×10⁻⁴ due to the delay of the output pulse by a time which is independent of C. The infidelity from scattering against |+ [symbol] =(|g₀ [symbol] +|g₁ [symbol] /\sqrt{2} thus reaches a value of about 4×10⁻⁴. Since the atom will usually be initialized to the |+ [symbol] state during operation of the device, it may be desirable to minimize the infidelity of this interaction. This can be done by equally distributing the delays between the |g₀ [symbol] and |g₁ [symbol] states by delaying the reference pulse by a time difference Δt₀₁/2, adding path length cΔt₀₁/4 to the top waveguide. This results in a “delay corrected” infidelity of 2×10⁻⁴, which may be independent of both cavity cooperativity (for c>>1) and atomic state initialization.

In FIG. 5B, the photon leakage probability for a scattering interaction is plotted. Atomic spontaneous emission noise from the excited |e [symbol] state into modes other than the cavity mode at a rate γₛ results in a partial loss of the photon, resulting in an output pulse with total photon number ∫dt|φₒᵤₜ(t)|²<1. The probability Pₛ of spontaneous emission loss as

$${P}_{s} = 1 - \frac{\int dt {\vert {φ}_{out} ( t ) \vert}^{2}}{\int dt {\vert {φ}_{in} ( t ) \vert}^{2}} .$$

Spontaneous emission noise may only apply to the |1 [symbol] ⊗|g₁ [symbol] component of the photon⊗atom state; since the atom will usually be initialized to the |+ [symbol] state, if the possible input photon states can be averaged over, an average leakage probability of P̅ₛ=Pₛ/4 can be obtained. This average photon loss probability is plotted in FIG. 5B and ranges from about 5% to 0.0005% over the range of cooperativity values shown.

Some embodiments account for loss due to attenuation in the optical storage ring and insertion loss from the switches as an average loss per cycle L. To estimate the maximum circuit depth D attainable with an overall fidelity target, a “bulk fidelity” per cycle accounting for shape infidelity, spontaneous emission loss, and attenuation while propagating through the storage ring and optical switches is computed. In certain embodiments, the circuit operates on only a single photonic qubit and that the photon is scattered against the atom with every pass through the storage ring. Estimated single-qubit circuit depth achievable while maintaining >50% fidelity as a function of cavity cooperativity and photon attenuation per cycle, assuming one scattering interaction every cycle, in accordance with an embodiment is illustrated in FIG. 5C. The achievable circuit depth operating with success probability [symbol] _{target} is thus the maximum D satisfying [ [symbol] _{target}×(1−Pₛ)×(1−L)]^{D}≥ [symbol] _{target}, which is plotted as a function of cavity cooperativity and propagation loss for [symbol] _{target}=50%. Using optimistic but not unrealistic values for cooperativity C=10⁴ and cycle loss L=10⁻⁴, a bulk fidelity of [symbol] ≈99.95% is computed. This allows for an estimated depth of D≈2000 scattering operations while maintaining 50% success rate, and results in an error probability per gate (EPG) of ˜5×10⁻⁴, below the estimated ˜10⁻³ EPG threshold for fault tolerance.

### DOCTRINE OF EQUIVALENTS

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

What is claimed is:

1. A photonic quantum computer comprising:
at least one photon source, wherein the photon source generates at least one single photon pulse, wherein at least one photonic qubit is encoded in the at least one single photon pulse;
at least one optical storage ring, wherein the at least one single photon pulse propagates the optical storage ring;
at least one optical switch, wherein the at least one switch is part of the optical storage ring;
at least one cavity comprising a single atom source and at least one laser, wherein the single atom source comprises an atomic qubit;
at least one beamsplitter;
at least one phase shifter; and
at least one mirror;
wherein the at least one optical switch directs the at least one single photon pulse from the at least one optical storage ring through the at least one beamsplitter and the at least one phase shifter into the at least one mirror;
wherein the directed at least one single photon pulse scatters with the single atom source and returns to the at least one optical storage ring; and
wherein the atomic qubit is projectively measured and teleported to the at least one photonic qubit.

2. The photonic quantum computer of claim 1, wherein the at least one photon source is either a single photon source or a laser.

3. The photonic quantum computer of claim 1, wherein the at least one optical storage ring is an optical fiber ring.

4. The photonic quantum computer of claim 1, wherein the single atom source is selected from the group consisting of: a single atom, a single quantum emitter, and a single quantum dot.

5. The photonic quantum computer of claim 4, wherein the single atom has a transition near 1550 nm.

6. The photonic quantum computer of claim 4, wherein the single atom is selected from the group consisting of: strontium, rubidium, caesium.

7. The photonic quantum computer of claim 1, wherein the single atom source has a ∧-shaped three-level structure.

8. The photonic quantum computer of claim 1, wherein the at least one mirror is a waveguide.

9. The photonic quantum computer of claim 8, wherein the at least one waveguide is coupled with the at least one cavity.

10. The photonic quantum computer of claim 1, wherein the at least one beamsplitter is a static 50:50 beamsplitter.

11. The photonic quantum computer of claim 1, wherein the at least one phase shifter is a π/4 phase shifter.

12. The photonic quantum computer of claim 1, wherein the at least one laser coherently controls the single atom source.

13. The photonic quantum computer of claim 1, wherein the photon source generates two single photon pulses, and a first of the two single photon pulses propagates the optical storage ring in a clockwise direction and a second of the two single photon pulses propagates the optical storage ring in a counter clockwise direction.

14. The photonic quantum computer of claim 1, wherein the photonic quantum computer is deterministic.

15. The photonic quantum computer of claim 1, wherein the photonic quantum computer uses a synthetic time dimension.

16. A method for performing photonic quantum computing comprising:
generating at least one single photon pulse from a photon source, wherein at least one photonic qubit is encoded in the at least one single photon pulse;
propagating the at least one single photon pulse in at least one optical storage ring;
using at least one optical switch on the at least one optical storage ring to direct the at least one single photon pulse through at least one beamsplitter and through at least one phase shifter;
directing the at least one single photon pulse to scatter with a single atom source in at least one cavity, wherein the single atom source comprising a atomic qubit;
returning the at least one single photon pulse to the at least one optical storage ring;
applying a rotation to the atomic qubit;
performing a projective measurement to the atomic qubit; and
teleporting the rotation of the atomic qubit onto the photonic qubit;
wherein the single atom source is controlled by at least a laser source.

17. The method of claim 16, wherein at least three sets of the teleported rotations are performed.

18. The method of claim 16, further comprising constructing at least one arbitrary single-qubit gate.

19. The method of claim 16, further comprising constructing a two-photon entangling gate.
